(19) United States
(12) Patent Application Publication
(10) Pub. No.: US 2016/0289613 A1
(43) Pub. Date: Oct. 6, 2016

(54) PRESERVATIVE SYSTEM FOR WASHING AGENTS

(71) Applicant: Henkel AG & Co. KGaA, Duesseldorf (DE)

(72) Inventors: Doris Dahlmann, Duesseldorf (DE); Martina Seiler, Duisburg (DE); Sheila Edwards, Duesseldorf (DE)

(73) Assignee: Henkel AG & Co. KGaA, Duesseldorf (DE)

(21) Appl. No.: 15/180,581

(22) Filed: Jun. 13, 2016

Related U.S. Application Data
(63) Continuation of application No. PCT/EP2014/077047, filed on Dec. 9, 2014.

(30) Foreign Application Priority Data
Dec. 18, 2013 (DE) 10 2013 226 426.7

(51) Int. Cl. C11D 3/48; C11D 11/00; C11D 1/72; C11D 1/66; C11D 1/14; C11D 1/831

(52) U.S. Cl. CPC C11D 3/48; C11D 1/146; C11D 1/831; C11D 1/72; C11D 1/662; C11D 11/0017

(57) ABSTRACT

The present invention relates to a washing agent, in particular a liquid washing agent, containing a preservative system consisting of 2-methyl-2H-isothiazol-3-one (MIT) in combination with 3-iodo-2-propynyl butylcarbamate (IPBC) and to washing methods using such a washing agent and to the use of said preservative system for stabilizing washing and cleaning agents.

### FIELD OF THE INVENTION

The present invention generally relates to washing agents, particularly liquid washing agents,that contain a specific combination of preservatives in addition to anionic and nonionic surfactants, and methods for the use of said washing agents.

### BACKGROUND OF THE INVENTION

Although in the past few decades great progress has been made in replacing ecologically harmful ingredients such as phosphate with other ingredients in washing agents, there is still a need for washing agents, particularly liquid washing agents, the environmental friendliness of which is further improved.

In washing agents that mainly contain nonionic surfactants, particularly fatty alcohol ethoxylates such as Dehydol LT 7 and alkyl polyglycosides such as APG 600, and that contain little anionic surfactants, particularly fatty alcohol ether sulfates such as Texapon N 70, common preservatives such as 2-phenylphenol (commercially available as Preventol ON Extra from Lanxess) and mixtures of 1,2-benzisothiazol-3(2H)-one and 2-methyl-2H-siothiazol-3-one (commercially available as Acticide MBS 2550) are suitable, e.g., for an Ecolabel declaration but do not have sufficient stability and do not exhibit sufficient antifungal or antibacterial activity in the surfactant mixture mentioned above.

Therefore, the problem that was addressed by the present invention is that of providing a washing agent, preferably a liquid washing agent, that is based on the surfactant system mentioned above and both is highly environmentally friendly (e.g., can be registered by means of an Ecolabel declaration of the European Union in accordance with Regulation (EC) No 66/2010 of the European Parliament and of the Council of 25 Nov. 2009 on the EU Ecolabel) and has a long storage life and good washing performance in comparison with traditional washing agent formulations. For the evaluation of appropriate environmental friendliness in accordance with Ecolabel of the European Union, a standard, particularly for the registration of washing agents, is that the washing agents pose little hazard to the water and biotopes and do not contain any hazardous substances, the algae growth in the water is hardly influenced, little packaging is used, ecological and economical washing is communicated to the consumer, the cleaning action is developed at least as in the case of conventional products, and the ingredients are biodegradable. Accordingly, environmentally friendly washing agents preferably contain only such ingredients that are effective and nevertheless do not harm the environment. These are expressly in particular such ingredients that do not have to be ecologically labeled in accordance with the H statements and EUH statements (for example, in accordance with Regulation (EC) No 1272/2008 of the European Parliament and of the Council of 16 Dec. 2008).

Surprisingly, the inventors have determined that a washing agent based on the surfactant system described above that has a preservative containing 2-methyl-2H-isothiazol-3-one (MIT) in combination with 3-iodo-2-propynyl butylcarbamate (IPBC) and is highly environmentally friendly and has good washing performance in comparison with traditional washing agent formulations, also has a very good storage life.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A washing agent, preferably a liquid washing agent, characterized in that the washing agent contains, with respect to the total weight of the washing agent: 12 to 20 wt %, preferably 15 to 18 wt %, especially preferably 16.5 wt %, of nonionic surfactants; 1 to 4 wt %, preferably 1.5 to 3 wt %, especially preferably 2 wt %, of anionic surfactants; and 2-methyl-2H-isothiazol-3-one (MIT) in combination with 3-iodo-2-propynyl butylcarbamate (IPBC).

The use of a preservative consisting of 2-methyl-2H-isothiazol-3-one (MIT) in combination with 3-iodo-2-propynyl butylcarbamate (IPBC) to stabilize and/or preserve surfactant-containing washing or cleaning agents.

### BRIEF DESCRIPTION OF THE DRAWINGS

The present invention will hereinafter be described in conjunction with the following drawing figures, wherein like numerals denote like elements, and

FIG. 1 shows evaluation criteria of the “standard challenge test” test method.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

In a first aspect, the invention relates to a washing agent, preferably a liquid washing agent, containing (a) 12 to 20 wt %, preferably 15 to 18 wt %, especially preferably 16.5 wt %, of nonionic surfactants, (b) 1 to 4 wt %, preferably 1.5 to 3 wt %, especially preferably 2 wt %, of anionic surfactants, characterized in that the washing agent contains 2-methyl-2H-isothiazol-3-one (MIT) in combination with 3-iodo-2-propynyl butylcarbamate (IPBC) as a preservative.

The present invention also relates to a washing method, comprising the following steps:
a) providing a washing or cleaning solution comprising a washing agent, preferably a liquid washing agent, as described above, and
b) bringing a textile or a hard surface in contact with the washing or cleaning solution according to a).

Another aspect relates to the use of a preservative consisting of 2-methyl-2H-isothiazol-3-one (MIT) in combination with 3-iodo-2-propynyl butylcarbamate (IPBC) to stabilize and/or preserve surfactant-containing washing agents or cleaning agents.

The agents can be washing agents for textiles, carpets, or natural fibers. The washing agents in the context of the invention also include auxiliary washing agents that can be added to the actual washing agent in a metered manner during the manual washing of textiles or the washing of textiles by machine in order to achieve further action. The washing agents in the context of the invention also include textile pre-treatment and post-treatment agents, i.e., agents with which the item to be washed is brought in contact before the actual washing, for example in order to partially dissolve tenacious soil, and also agents that give the goods to be washed further desirable characteristics such as pleasant texture, freedom from wrinkles, or low static charge in a step following the actual textile washing.

All amount specifications, unless explicitly otherwise stated, relate to wt % with respect to the total weight of the washing agent. Furthermore, such amount specifications that relate to at least one constituent always relate to the total amount of this type of constituent that is contained in the washing agent, unless something different is explicitly stated. This means that such amount specifications, for example in connection with “at least one nonionic surfactant”, relate to the total amount of nonionic surfactants that is contained in the washing agent.

“At least one”, as used herein, refers to 1 or more, for example 1, 2, 3, 4, 5, 6, 7, 8, 9 or more. In connection with constituents of the compositions described herein, this specification relates not to the absolute amount of molecules but rather to the type of the constituent. Therefore, “at least one nonionic surfactant” means, for example, one or more different nonionic surfactants, i.e., one or more different types of nonionic surfactants. Together with amount specifications, the amount specifications relate to the total amount of the accordingly indicated type of constituent, as already defined above.

In a preferred embodiment, the washing agent contains a mixture of MIT and IPBC at a weight ratio between 2:1 and 1:2 as a preservative, particularly in a total amount with respect to the washing agent of 0.001 to 0.05 wt %. An especially preferred weight ratio of MIT and IPBC is 2:1.

The described washing agents contain 1 to 4 wt %, preferably 1.5 to 3 wt %, especially preferably 2 wt %, of anionic surfactants and 12 to 20 wt %, preferably 15 to 18 wt %, especially preferably 16.5 wt %, of nonionic surfactants.

Suitable anionic surfactants comprise, without being restricted thereto, alkylbenzene sulfonates, olefin sulfonates, alkane sulfonates, fatty alcohol sulfates, fatty alcohol ether sulfates, or a mixture of two or more of said anionic surfactants. Of said anionic surfactants, especially preferred are alkylbenzene sulfonates, fatty alcohol ether sulfates, and mixtures thereof. Further suitable anionic surfactants are soaps, i.e., salts of fatty acids, particularly the Na or K salts of C₁₂₋₁₈ fatty acids. Soaps can in particular have an advantageous effect on the cold washing performance. In particular, such anionic surfactants that are suitable for the EU Ecolabel declaration are preferred.

In general, alkylbenzene sulfonates and olefin sulfonates, i.e., mixtures of alkene and hydroxyalkane sulfonates and of disulfonates, which can be obtained, for example, from C₁₂₋₁₈ monoolefins having a terminal or internal double bond by sulfonation with gaseous sulfur trioxide and subsequent alkaline or acid hydrolysis of the sulfonation products, are considered as surfactants of the sulfonate type. C₁₂₋₁₈ alkane sulfonates and the esters of α-sulfo fatty acids (ester sulfonates), for example the a-sulfonated methyl esters of the hydrogenated coconut, palm kernel, and tallow fatty acids, are also suitable.

Alkylbenzene sulfonates are preferably selected from linear alkylbenzene sulfonates of the formula

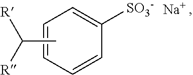

in which R′ and R″ are independently H or alkyl and together contain 9 to 19, preferably 9 to 15, and particularly 9 to 13, C atoms. A very especially preferred representative is sodium dodecylbenzenesulfonate.

The salts of the sulfuric acid half-esters of the C₁₂-C₁₈ fatty alcohols, for example from coconut fatty alcohol, tallow fatty alcohol, lauryl alcohol, myristyl alcohol, cetyl alcohol, stearyl alcohol, or the C₁₀-C₂₀ oxo alcohols, and those semi-esters of secondary alcohols of these chain lengths are preferred as alk(en)yl sulfates. With regard to washing, the C₁₂-C₁₆ alkyl sulfates and C₁₂-C₁₅ alkyl sulfates and C₁₄-C₁₅ alkyl sulfates are preferred.

However, the alkyl ether sulfates having the formula

R¹—O-(AO)ₙ—SO₃⁻X⁺

are especially preferred in the context of the present invention.

In this formula, R¹ stands for a linear or branched, substituted or unsubstituted alkyl residue, preferably for a linear, unsubstituted alkyl residue, especially preferably for a fatty alcohol residue. Preferred residues R¹ are selected from decyl, undecyl, dodecyl, tridecyl, tetradecyl, pentadecyl, hexadecyl, heptadecyl, octadecyl, nonadecyl, and eicosyl residues and mixtures thereof, wherein the representatives having an even number of C atoms are preferred. Especially preferred residues R¹ are derived from C₁₂-C₁₈ fatty alcohols, for example from coconut fatty alcohol, tallow fatty alcohol, lauryl alcohol, myristyl alcohol, cetyl alcohol, or stearyl alcohol or from C₁₀-C₂₀ oxo alcohols.

AO stands for an ethylene oxide (EO) or propylene oxide (PO) grouping, preferably for an ethylene oxide grouping. The index n stands for an integer from 1 to 50, preferably from 1 to 20, particularly from 2 to 10. Very especially preferably, n stands for the numbers 2, 3, 4, 5, 6, 7, or 8. X stands for a monovalent cation or the nth part of an n-valent cation, the alkali metal ions and among them Na⁺ or K⁺ being preferred, wherein Na⁺ is extremely preferred. Further cations X+ can be selected from NH₄⁺, ½Zn²⁺, ½Mg²⁺, ½Ca²⁺, ½Mn²⁺, and mixtures thereof.

Very especially preferred washing agents contain an alkyl ether sulfate selected from fatty alcohol ether sulfates of the formula

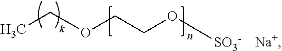

with k=11 to 19, n=2, 3, 4, 5, 6, 7, or 8. Very especially preferred representatives are Na C₁₂₋₁₄ fatty alcohol ether sulfates having 2 EOs (k=11-13, n=2 in formula A-1). The specified degree of ethoxylation is a statistical average that can be an integer or a rational number for a specific product. Preferred alkoxylates/ethoxylates have a narrow homolog distribution (narrow range ethoxylates, NRE).

In especially preferred embodiments, the washing agent therefore contains a C₁₂-C₁₄ fatty alcohol ether sulfate having 2 EOs in an amount of 1 to 4 wt %, especially 1.5 to 3 wt %, especially preferably 2 wt %. Such compounds are commercially available, for example under the trade name Texapon™ N70.

The anionic surfactants including the fatty acid soaps can be present in the form of the sodium, potassium, magnesium, or ammonium salts thereof. The anionic surfactants are preferably present in the form of the sodium salts and/or ammonium salts thereof. Amines that can be used for neutralization are preferably choline, triethylamine, monoethanolamine, diethanolamine, triethanolamine, methylethylamine, or a mixture thereof, wherein monoethanolamine is preferred.

Suitable nonionic surfactants comprise alkoxylated fatty alcohols, alkoxylated oxo alcohols, alkoxylated fatty acid alkyl esters, fatty acid amides, alkoxylated fatty acid amides, polyhydroxy fatty acid amides, alkylphenol polyglycol ethers, amine oxides, alkyl (poly)glucosides, and mixtures thereof.

Preferred washing agents contain at least one fatty alcohol alkoxylate of the formula

R²—O-(AO)ₘ—H,

in which

R² stands for a linear or branched, substituted or unsubstituted alkyl residue,

AO stands for an ethylene oxide (EO) or propylene oxide (PO) grouping,

m stands for integers from 1 to 50.

In the formula stated above, R² stands for a linear or branched, substituted or unsubstituted alkyl residue, preferably for a linear, unsubstituted alkyl residue, especially preferably for a fatty alcohol residue. Preferred residues R² are selected from decyl, undecyl, dodecyl, tridecyl, tetradecyl, pentadecyl, hexadecyl, heptadecyl, octadecyl, nonadecyl, and eicosyl residues and mixtures thereof, wherein the representatives having an even number of C atoms are preferred. Especially preferred residues R² are derived from C₁₂-C₁₈ fatty alcohols, for example from coconut fatty alcohol, tallow fatty alcohol, lauryl alcohol, myristyl alcohol, cetyl alcohol, or stearyl alcohol or from C₁₀-C₂₀ oxo alcohols.

AO stands for an ethylene oxide (EO) or propylene oxide (PO) grouping, preferably for an ethylene oxide grouping. The index m stands for an integer from 1 to 50, preferably from 1 to 20, particularly from 2 to 10. Very especially preferably, m stands for the numbers 2, 3, 4, 5, 6, 7, or 8.

In summary, especially preferred fatty alcohol alkoxylates are those of the formula

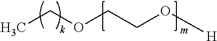

with k=11 to 19, m=2, 3, 4, 5, 6, 7, or 8. Very especially preferred representatives are C₁₂₋₁₈ fatty alcohols having 5-9, particularly 7, EOs (k=11-17, m=7 in formula C-1). They are preferably contained in an amount of 12 to 18 wt %, preferably 13 to 16 wt %, especially preferably 14 wt %, with respect to the washing agent. Such compounds are commercially available, for example under the trade name Dehydol™ LT 7.

As a further surfactant, the washing agent can contain a nonionic surfactant of the formula

R¹O-[G]ₚ,

in which R¹ stands for a linear or branched alkyl having 8 to 26, preferably 10 to 20, more preferably 12 to 18 or 12 to 16, carbon atoms, G stands for a sugar residue having 5 or 6 carbon atoms, and p stands for numbers from 1 to 10. G can stand for sugars having 5 carbon atoms (pentoses) or 6 carbon atoms (hexoses). The degree of oligomerization p can be 1 to 10.

Especially preferred nonionic surfactants are derived from glucose and can be described by the following formula:

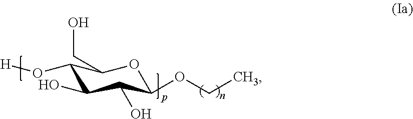

in which n stands for 11 to 15 and p stands for numbers from 1 to 10.

The degree of oligomerization in the formulas stated above is preferably <8, more preferably <6, even more preferably <4, and particularly <2. Especially preferred surfactant mixtures or washing or cleaning agents according to the invention contain nonionic surfactants in which p stands for numbers from 1.4 to 1.8.

These fractional degrees of oligomerization are realized by means of mixtures that contain varying amounts of surfactants of the above formulas, in which p stands for an integer, preferably for 1, 2, 3, or 4, for the individual molecule.

In summary, washing agents preferred according to the invention are characterized in that they contain C₁₂-C₁₆ alkyl oligo(1,4)-glucoside in an amount of 1 to 4 wt %, especially preferably 1.5 to 3 wt %, and especially preferably 2.5 wt %, with respect to the total amount of the washing agent. Such compounds are commercially available, for example under the trade name APG 600.

In principle, all amine oxides established for these purposes in the prior art, amine oxides being compounds having the formula R¹R²R³NO, wherein each R¹, R², and R³ is a possibly substituted C₁-C₃₀ hydrocarbon chain independently of the others, can be used as an amine oxide. Amine oxides especially preferably used are those in which R¹ is C₁₂-C₁₈ alkyl and R² and R³ are independently C₁-C₄ alkyl, particularly C₁₂-C₁₈ alkyl dimethyl amine oxides. Representatives of suitable amine oxides serving as examples are N-coco alkyl-N,N-dimethylamine oxide, N-tallow alkyl-N,N-dihydroxyethylamine oxide, myristyl/cetyl dimethyl amine oxide, or lauryl dimethyl amine oxide.

Preferred washing agents contain, with respect to the total weight of the washing agent, 1 to 4 wt %, preferably 1.5 to 3 wt %, especially preferably 2 wt %, of alkyl ether sulfate(s), particularly fatty alcohol ether sulfate(s), 1 to 4 wt %, preferably 1.5 to 3 wt %, more preferably 2.5 wt %, of alkyl poly/oligo-glucoside(s), and 12 to 18 wt %, preferably 13 to 16 wt %, especially preferably 14 wt %, of fatty alcohol ethoxylates.

In a preferred embodiment, the washing agent contains fatty alcohol ethoxylates, particularly C₁₂-C₁₈ fatty alcohol ethoxylates having 5-9 EOs, in an amount of 12 to 18 wt %, preferably 13 to 16 wt %, especially preferably 14 wt %; C12-C16 alkyl oligo(1,4)-glucosides in an amount of 1 to 4 wt %, preferably 1.5 to 3 wt %, especially preferably 2.5 wt %; and/or C₁₂-C₁₄ fatty alcohol ether sulfates having 2 EOs in an amount of 1 to 4 wt %, especially 1.5 to 3 wt %, especially preferably 2 wt %. In preferred embodiments, all three constituents are contained in the specified amounts.

It has proven to be advantageous for the cold washing performance if the washing agents additionally contain soap(s). Therefore, preferred washing agents are characterized in that they contain, with respect to the weight thereof, 0.25 to 15 wt %, preferably 0.5 to 12.5 wt %, more preferably 1 to 10 wt %, even more preferably 1.5 to 7.5 wt %, and particularly 2 to 6 wt %, of soap(s). Soaps of C₁₂-C₁₈ fatty acids are especially preferred.

The washing agent can additionally contain further ingredients that further improve the usage characteristics and/or aesthetic characteristics of the washing agent. In the context of the present invention, the washing agent preferably additionally contains one or more substances from the group of the enzymes, bleaches, complexing agents, builders, electrolytes, non-aqueous solvents, pH adjusters, perfumes, perfume carriers, fluorescent agents, dyes, hydrotropes, antifoaming agents, silicone oils, anti-redeposition agents, anti-graying agents, anti-shrinkage agents, anti-creasing agents, dye transfer inhibitors, antioxidants, corrosion inhibitors, antistatic agents, bitterants, ironing aids, repellents, impregnants, anti-swelling agents, anti-slip agents, softening components, and UV absorbers.

In various embodiments, the washing agent can contain further preservatives, antimicrobial active ingredients, germicides, and/or fungicides. However, it is preferred that the washing agent does not contain any further substances of this type beyond those mentioned according to the invention.

The washing agent preferably contains at least one enzyme. In principle, all enzymes established for these purposes in the prior art can be used in this regard. The at least one enzyme is preferably one or more enzymes that can develop catalytic activity in a washing agent, particularly a protease, amylase, lipase, cellulase, hemicellulase, mannanase, pectin-cleaving enzyme, tannase, xylanase, xanthanase, β-glucosidase, carrageenase, perhydrolase, oxidase, oxidoreductase, and mixtures thereof. Preferred hydrolytic enzymes comprise, in particular, proteases, amylases, particularly α-amylases, cellulases, lipases, hemicellulases, particularly pectinases, mannanases, β-glucanases, and mixtures thereof. Proteases, amylases, and/or lipases and mixtures thereof are especially preferred, and proteases are very especially preferred. In principle, these enzymes are of natural origin; on the basis of the natural molecules, variants improved for use in washing agents are available and are accordingly preferably used.

Furthermore, the enzymes to be used can be formulated together with accompanying substances, for example from the fermentation, or with stabilizers.

All substances that destroy and/or take up dyes by means of oxidation, reduction, or adsorption and thereby bleach materials can serve as a bleach. This includes, among other things, hypohalite-containing bleaches, hydrogen peroxide, perborate, percarbonate, peroxyacetic acid, diperoxyazelaic acid, diperoxydodecanedioic acid, and oxidative enzyme systems.

In particular silicates, aluminum silicates (particularly zeolites), carbonates, salts of organic di- and polycarboxylic acids, and mixtures of these substances should be mentioned as builders that can be contained in the washing agent.

Organic builders that can be present in the washing agent are, for example, the polycarboxylic acids, which can be used in the form of the sodium salts thereof, wherein those carboxylic acids that bear more than one acid function are understood by polycarboxylic acids. These are, for example, citric acid, adipic acid, succinic acid, glutaric acid, malic acid, tartaric acid, maleic acid, fumaric acid, sugar acids, and mixtures thereof. Preferred salts are the salts of the polycarboxlyic acids such as citric acid, adipic acid, succinic acid, glutaric acid, tartaric acid, sugar acids, and mixtures thereof.

Polymeric polycarboxylates are also suitable as builders. These are, for example, the alkali metal salts of polyacrylic acid or polymethacrylic acid, for example those having a relative molecular mass of 600 to 750,000 g/mol.

Suitable polymers are, in particular, polyacrylates, which preferably have a molecular mass of 1,000 to 15,000 g/mol. Because of the superior solubility thereof, the short-chain polyacrylates having molar masses of 1,000 to 10,000 g/mol, and especially preferably 1,000 to 5,000 g/mol, can in turn be preferred from this group.

Also suitable are copolymeric polycarboxylates, particularly those of acrylic acid with methacrylic acid and of acrylic acid or methacrylic acid with maleic acid. To improve the water solubility, the polymers can also contain allyl sulfonic acids, such as allyl oxybenzene sulfonic acid and methallyl sulfonic acid, as monomers.

In liquid washing agents, soluble builders, such as citric acid, or acrylic polymers having a molar mass of 1,000 to 5,000 g/mol, are preferably used.

Preferred washing agents are liquid and preferably contain water as a main solvent. It is preferred that the washing agent contains, with respect to the total amount of washing agent, more than 5 wt %, preferably more than 15 wt %, and particularly preferably more than 25 wt %, of water. Especially preferred liquid washing agents contain, with respect to the weight thereof, 5 to 90 wt %, preferably 10 to 85 wt %, especially preferably 25 to 75 wt %, and particularly 35 to 65 wt %, of water. Alternatively, the washing agents can be low-water or water-free washing agents, wherein, in a preferred embodiment, the content of water is less than 10 wt %, and more preferably less than 8 wt %, with respect to the total liquid washing agent.

In addition, non-aqueous solvents can be added to the washing agent. Suitable non-aqueous solvents comprise mono- or multivalent alcohols, alkanolamines, or glycol ethers, provided that they are miscible with water in the specified concentration range. The solvents are preferably selected from ethanol, n-propanol, i-propanol, butanols, glycol, propanediol, butanediol, methylpropanediol, glycerin, diglycol, propyldiglycol, butyldiglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, methoxytriglycol, ethoxytriglycol, butyoxytriglycol, 1-butoxyethoxy-2-propanol, 3-methyl-3-methoxybutanol, propylene glycol t-butyl ether, di-n-octylether, and mixtures of these solvents. However, it is preferred that the washing agent contains an alcohol, particularly ethanol and/or glycerin, in amounts between 0.5 and 5 wt %, with respect to the total washing agent.

Methods for cleaning textiles are generally distinguished in that, in several steps, various cleaning-active substances are applied to the goods to be cleaned and washed off after the exposure time, or that the goods to be cleaned are treated with a washing agent or a solution of said agent in another way.

In the described washing methods, temperatures of 30° C. or less, for example 20° C. or less, are used in various embodiments. These temperature specifications relate to the temperatures used in the washing steps.

All facts, subject matter, and embodiments that are described for the washing agents also can be applied to the washing method and the use and vice versa.

The washing agents described herein, particularly the low-water to water-free liquid washing agents described, can be introduced into a water-soluble casing and thus be part of a water-soluble package. If the washing agent is packaged in a water-soluble casing, it is preferred that the content of water is less than 10 wt %, with respect to the total washing agent, and that anionic surfactants, if present, are in the form of the ammonium salts thereof.

Neutralization with amines, differently than in the case of bases such as NaOH or KOH, does not lead to the formation of water. Therefore, low-water washing agents that are directly suitable for use in water-soluble casings can be produced.

A water-soluble package contains a water-soluble casing in addition to the washing agent. The water-soluble casing is preferably formed by a water-soluble film material.

Such water-soluble packages can be produced either by means of methods of vertical forming, filling, and sealing (VFFS) or hot-forming methods.

The hot-forming method generally includes the shaping of a first layer composed of a water-soluble film material in order to form bulges for accommodating a composition therein, introducing the composition into the bulges, covering the bulges filled with the composition with a second layer composed of a water-soluble film material, and sealing the first and second layers to each other at least around the bulges.

The water-soluble casing is preferably formed of a water-soluble film material selected from the group comprising polymers or polymer mixtures. The casing can be formed of one or two or more layers of the water-soluble film material. The water-soluble film material of the first layer and of the further layers, if present, can be the same or different.

The water-soluble package, comprising the washing agent and the water-soluble casing, can have one or more chambers. The liquid washing agent can be contained in one or more chambers, if present, of the water-soluble casing. The amount of liquid washing agent preferably corresponds to the full dose or half of the dose that is needed for a washing cycle.

It is preferred that the water-soluble casing contains polyvinyl alcohol or a polyvinyl alcohol copolymer.

Suitable water-soluble films for producing the water-soluble casing are preferably based on a polyvinyl alcohol or a polyvinyl alcohol copolymer, the molecular weight of which lies in the range of 10,000 to 1,000,000 gmol−1, preferably 20,000 to 500,000 gmol−1, especially preferably 30,000 to 100,000 gmol−1, and particularly 40,000 to 80,000 gmol−1.

Polymers selected from the group comprising acrylic-acid-containing polymers, polyacrylamides, oxazoline polymers, polystyrene sulfonates, polyurethanes, polyesters, polyether polylactic acid, and/or mixtures of the polymers above can additionally be added to a film material suitable for producing the water-soluble casing.

Preferred polyvinyl alcohol copolymers comprise dicarboxylic acids as further monomers in addition to vinyl alcohol. Suitable dicarboxylic acids are itaconic acid, malonic acid, succinic acid, and mixtures thereof, wherein itaconic acid is preferred.

Likewise preferred polyvinyl alcohol copolymers comprise an ethylenically unsaturated carboxylic acid, salt thereof, or ester thereof in addition to vinyl alcohol. Such polyvinyl alcohol copolymers especially preferably contain acrylic acid, methacrylic acid, acrylic acid ester, methacrylic acid ester, or mixtures thereof in addition to vinyl alcohol.

Suitable water-soluble films for use in the casings of the water-soluble packages according to the invention are films that are sold by MonoSol LLC, for example under the designation M8630, C8400, or M8900. Other suitable films comprise films having the designation Solublon® PT, Solublon® GA, Solublon® KC, or Solublon® KL from Aicello Chemical Europe GmbH or the films VF-HP from Kuraray.

The water-soluble packages can have a substantially dimensionally stable spherical and cushion-shaped design having a circular, elliptical, square, or rectangular basic shape.

The water-soluble package can have one or more chambers for storing one or more agents. If the water-soluble package has two or more chambers, at least one chamber contains a liquid washing agent. The further chambers can each contain a solid or a liquid washing agent.

### EXAMPLES

The Ecolabel washing agent formulation of Table 1 was used, and the compositions E1, V1, and V2 were produced with the preservatives according to Table 2 (vide infra).

TABLE 1
Frame formulation for E1, V1, and V2

| Raw material | wt % |
|---|---|
| Glycerin | 7.50 |
| NaOH | ad pH 8.5 |
| Citric acid | 2.25 |
| C₁₂₋₁₄ fatty alcohol ethoxylated with 7 mol | 14.00 |
| of ethylene oxide | |
| APG 600 | 2.50 |
| C₁₂₋₁₈ fatty acid sodium salt | 1.20 |
| Fatty alcohol ether sulfate ethoxylated with | 4.00 |
| 2 mol of ethylene oxide | |
| Ethanol | 2.00 |
| Enzymes | 0.40 |
| Perfume | 0.25 |
| Preservative | see Table 2 |
| Water | ad 100 |

Principle of the challenge test method

The method is used to test the stability of raw materials, premixtures, and end products against microbial spoilage.

For the test method, freshly produced washing agent formulations and stored washing agent formulations (12 weeks of storage are typical) in general can be examined in a so-called challenge test. The examples given below relate to freshly produced samples. However, similar results were also obtained with samples stored accordingly (4 weeks for 40° C.).

The sample to be examined was artificially inoculated (loaded) with representative bacteria and fungi. The dying off of the microorganisms was quantitatively tracked at defined test times.

Specification

The preservation of the samples is considered to be sufficient if the inoculation colonies (bacteria and fungi) are killed to <10 cfu/g within 35 days in the standard challenge test.

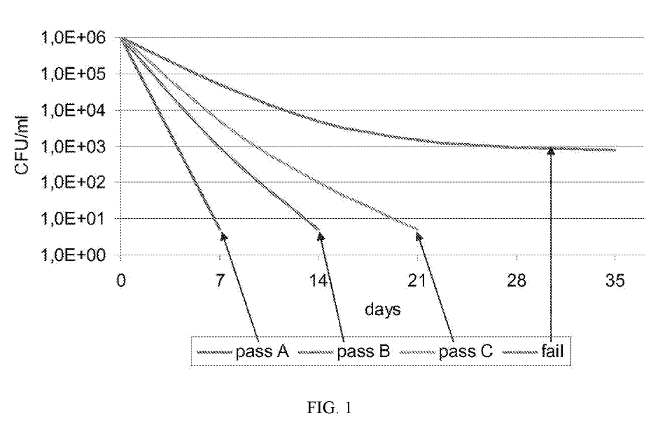

The microbe cells of the inoculated formulation were measured at defined intervals for a duration of 4 weeks. Each time, the viable cell counts were calculated and compared with the minimum requirements of the test series. This evaluation of the standard challenge test and the categorization occurred schematically according to FIG. 1.

All ABC criteria according to FIG. 1 show the effectiveness of the preservative as a function of time. All products with an ABC level are adequately preserved and pass the test. Category C means that the preservative must be used in high concentrations in order to ensure appropriate activity and product stability. However, high concentrations are usually accompanied by less environmental friendliness.

TABLE 2
Test results

| Formu- | Preservative | | | | | |
|---|---|---|---|---|---|---|
| lation | | Amount | Test result | | | |
| Number | Name | [wt %] | Bacteria | Fungi | Result | Category |
| V1 | Preventol | 0.25 | 28 | >35 | failed | — |
| | ON | | | d35: | | |
| | extra ®¹ | | | >1.0 × 10³ | | |
| V2 | Acticide | 0.10 | 7 | >28 | failed | — |
| | MBS | | | d28: | | |
| | 2550 ®² | | | >1.0 × 10³ | | |
| E1 | Acticide | 0.05 | 7 | 7 | passed | A |
| | IMS ®³ | | | | | |

¹2-phenylphenol sodium salt (>99%) (from Lanxess)
²Combination of MIT (5 wt % of active substance), BIT (2.5 wt % of active substance) in water (from Thor Chemie)
²Combination of MIT (5 wt % of active substance), IPBC (2.5 wt % of active substance) in water (from Thor Chemie)

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A washing agent, preferably a liquid washing agent, characterized in that the washing agent comprises, with respect to the total weight of the washing agent:
(a) 12 to 20 wt %, preferably 15 to 18 wt %, especially preferably 16.5 wt %, of nonionic surfactants,
(b) 1 to 4 wt %, preferably 1.5 to 3 wt %, especially preferably 2 wt %, of anionic surfactants, and
(c) 2-methyl-2H-isothiazol-3-one (MIT) in combination with 3-iodo-2-propynyl butylcarbamate (IPBC).

2. The washing agent according to claim 1, characterized in that said washing agent comprises MIT and IPBC at a weight ratio between 2:1 and 1:2 in a total amount of 0.001 to 0.05 wt %.

3. The washing agent according to claim 1, characterized in that the nonionic surfactants are selected from the group consisting of fatty alcohol ethoxylates, alkyl polyglycosides, and mixtures thereof.

4. The washing agent according to claim 1, characterized in that the ionic surfactants are fatty alcohol ether sulfates.

5. The washing agent according to claim 1, characterized in that said washing agent comprises, with respect to the total weight of the washing agent:
(a) 12 to 18 wt %, of fatty alcohol ethoxylates, particularly C₁₂-C₁₈ fatty alcohol ethoxylates having 5-9, preferably 7, EOs;
(b) 1 to 4 wt %, of C₁₂-C₁₆ alkyl oligo(1,4)-glucosides; and
(c) 1 to 4 wt %, of C₁₂-C₁₄ fatty alcohol ether sulfates having 2 EOs.

6. The washing agent according to claim 1, characterized in that the agent also comprises at least one further constituent selected from the group consisting of enzymes, builders, bleaches, electrolytes, non-aqueous solvents, pH adjusters, perfumes, perfume carriers, fluorescent agents, dyes, hydrotropes, antifoaming agents, silicone oils, anti-redeposition agents, anti-graying agents, anti-shrinkage agents, anti-creasing agents, dye transfer inhibitors, antioxidants, corrosion inhibitors, antistatic agents, bitterants, ironing aids, repellents, impregnants, anti-swelling agents, anti-slip agents, softening components, and UV absorbers.

7. A washing method, comprising the following steps:
(a) providing a washing solution comprising a washing agent, preferably a liquid washing agent, according to claim 1, and
(b) bringing a textile in contact with the washing solution according to a).
